(19) United States
(12) Patent Application Publication
(10) Pub. No.: US 2007/0101539 A1
(43) Pub. Date: May 10, 2007

(54) Device for moving a movable furniture part

(76) Inventors: Harald Sutterlutti, Fussach (AT); Helmut Fitz, Lustenau (AT)

Correspondence Address: WENDEROTH, LIND & PONACK, L.L.P., 2033 K STREET N. W., SUITE 800, WASHINGTON, DC, 20006-1021, US

(21) Appl. No.: 11/639,156

(22) Filed: Dec. 15, 2006

Related U.S. Application Data
(63) Continuation of application No. PCT/AT05/00191, filed on Jun. 3, 2005.

(30) Foreign Application Priority Data
Jun. 18, 2004 (AT) A 1036/2004

(51) Int. Cl. E05F 3/00

(52) U.S. Cl. 16/49; 16/71

(57) ABSTRACT

The invention relates to a device for moving a moving furniture component, mounted in or on a piece of furniture, in particular, a drawer or door, comprising a closing device for retracting the moving furniture component into a closed end position in or on the piece of furniture, whereby the closing device comprises a driver, for driving the moving furniture component and an energy store, in particular, at least one spring, for tensioning the driver, whereby the device comprises an electric motor for powering the driver.

The present invention relates to a device for moving a movable furniture part, in particular a drawer or a door, which is arranged in or on a furniture body, with a closing device to retract the movable furniture part into a closed, final position in or on the body of furniture, wherein the closing device has a catch to carry the movable furniture part and an energy-storing device, in particular at least one spring, to act upon the catch.

Devices with such closing devices have long been known in the art. These involve the catch of the closing device grasping the movable furniture part, which moves freely over the majority of the distance between the closed final position in or on the body of furniture and the fully open final position, in the rear retraction area and reliably drawing it into the closed final position.

It is object of the present invention to improve the ease of use of generic devices.

This is achieved according to the invention in that the device comprises an electromotor to drive the catch.

This makes it possible to reduce or even to eliminate the expenditure of energy applied by a user in order to overcome the closing device in generic devices during the opening procedure of a movable furniture part.

Since the closing device, in order to retract the movable furniture part, only in fact has to engage with the movable furniture part over a part of the total path on the approach to the closed end position, it is preferable to make provision that the catch is detachably coupleable with the movable furniture part. For example, provision can be made that a pin member moving with the movable furniture part is detachably lockable into an indentation disposed on the catch.

In an advantageous embodiment of the invention, provision is made that the catch is disposed on a movable slide. The slide can thereby be arranged so as to be linearly displaceable with respect to a housing. Thus the motion of the slide and thereby the movement of the catch can be stabilized.

In this connection, provision can be made that the catch is rigidly connected with the catch and is preferably made in one piece with the slide. Alternatively, provision may be made that the catch is movably, preferably tiltably, connected with the slide. For this purpose, for example, the catch can be arranged via a pin on the slide. This allows the catch to pivot away into a parking position, out of which it can be moved by the movable furniture part during its closing process.

The provided energy-storing device for retracting the movable furniture part into the closed final position can, for example, comprise a spring. For example the spring can be anchored on an anchoring member and engage either on the slide or directly on the catch.

The movable furniture part can, as known in the art, be retracted by contacting a pin member which moves with the moveable furniture part with the catch of the closing device into the parking position thereof.

In an advantageous embodiment of the invention, provision is made that the device has a ram acted upon the electromotor to actuate the catch or the slide. This allows the opening force to be exerted with precision on the slide or on the catch.

In a further advantageous embodiment of the invention, provision is made that the ram is linked with the catch or the slide, preferably pivotably thereto. This allows the electromotor to remain engaged over the entire movement path of the catch or the slide with these latter. This allows the retraction movement of the movable furniture part to be supported by the electromotor.

Alternatively, provision can be made that the ram loosely abuts against the catch or on the slide. In this case, the ram can be retracted into its initial position as soon as the opening procedure ends.

Unlike generic devices in which the energy-storing devices provided to act upon the closing device are charged manually by the user, in the device according to the invention, the energy-storing device can be charged by the electromotor.

It is especially preferable to make provision that the electromotor provided in the device according to the invention is not a general device for converting electrical into mechanical energy, but an electromotor in the narrow sense, which comprises a stator, whereby the stator preferably comprises an electromagnet. Furthermore the electromotor also comprises a rotor which rotates in relation to the stator, said rotor preferably comprising at least one permanent magnet.

Electromotors of this type are commercially available at low cost in space-saving constructions.

In a further embodiment, provision is made that the electromotor is in the form of a linear motor.

Linear motors of this type have the advantage that no gears are necessary to convert the rotation of the motor for the desired linear exertion of force.

It is thereby especially advantageous to provide a linear motor having a stator, wherein for preference the stator comprises at least one electromagnet. Preferably the stator comprises at least two coils separate from each other, which are arranged in a sleeve bearing. Provision may also be made that the linear motor includes a runner linearly displaceable in relation to the stator (direct linear motor). This can incorporate at least one permanent magnet.

The linear motor can either abut loosely against the movable furniture part or on a closing device for the movable furniture part or be rigidly connected thereto. If the linear motor is rigidly connected with the movable furniture part it can take over the functions of the closing device, which can then be omitted.

In an advantageous embodiment of the invention, provision is made that the device has a ram acted upon the linear motor to act upon the movable furniture part. Naturally, as an alternative, as already described, provision can be made that the ram acts upon the catch or the slide of the closing device.

It is especially preferable for the ram to be disposed on the runner of the linear motor and preferably formed integrally thereto. This allows an especially compact construction.

In one especially preferred embodiment of the invention, provision is also made that the device includes a path-measuring device, which is preferably integrated into the electromotor. The path-measuring device can thereby be used to determine the position and/or the distance covered by the movable furniture part, by the catch of the closing device or by the slide of the closing device.

It is especially preferable for the path-measuring device to comprise an inductive or capacitive sensor.

Especially when the electromotor is in the form of a linear motor, inductive or capacitive sensors have the advantage that the path-measuring device can be realised without additional components and in a compact construction.

For example, a capacitive path-measuring device can be realised as follows:

The stator of the linear motor comprises two coils separated from each other arranged on a sleeve bearing. The runner of the linear motor, which comprises a permanent magnet, is displaceable in the coils and can be moved out from the first coil. This changes the capacity of the first coil, which allows the position of the runner of the linear motor to be determined. To determine a reference value, provision can be made for electrical contacting of one the two sleeve bearings with a condenser of known capacity. The electrical interconnection of the path-measuring device in an equivalent circuit diagram acts as a series circuit of the capacities of the two coils with the condenser, thus as a series circuit of three capacities, where the capacity of the first coil depends on how far the runner of the linear motor is moved out of it. This allows the position of the runner to be determined.

An inductive path-measuring device can be realised, for example, as follows:

The stator of the linear motor comprises two coils separated from each other on a sleeve bearing. The runner of the linear motor, which comprises a permanent magnet, is displaceable in the coils and can be moved out from the first coil. To measure the path, a sinusoidal AC measurement voltage is overlaid on the motor voltage. The low-frequency driving current is thus superimposed by a high-frequency AC measurement voltage (for example approx. 20 kHz). Due to the inertia of the motor, the AC measurement voltage, which can for example be in the range of between 1 and 5% of the motor voltage, has no effect whatsoever on the motion behaviour of the motor. If one now measures off the AC measurement voltage separately via both coils, the measured voltage amplitude is a function of the impedance of the respective coil, thus a function of the position of the runner. To measure off the two coils separately, a centre tap is also lead through on the connection of the two coils from the linear motor. The measured AC voltages are electronically filtered, amplified and divided in order to remove any DC field interference. The measurement signal obtained after division of the two partial AC measurement voltages is proportional to the position of the runner.

Another aspect of the invention relates to an extension guide for a movable furniture part, especially a drawer or a door, arranged in or on a body of furniture, with an extension rail attachable onto the movable furniture part and a mounting rail attachable onto the body of furniture, whereby the extension guide has a device according to the invention of the aforementioned type.

In order to fully pull out the movable furniture part, provision may also be made that a central rail is arranged between the extension rail and the mounting rail.

For example, both the electromotor and the closing device can be disposed on the mounting rail of the extension guide. For preference, a pin member may disposed on the extension rail. The pin member can, for example, be acted upon the electromotor. However, provision may also be made that the pin member is—preferably detachably—coupleable with the catch of the closing device.

Another aspect of the invention relates to a piece of furniture with at least one movable furniture part, especially a drawer or a door, characterised in having an inventive device of the type described above, wherein the device is preferably disposed in an extension guide of the type described above.

For preference, provision is made that the movable furniture part can be retracted by the closing device at least over a part of the total opening path leading up to the closed final position of the movable furniture part.

A further aspect of the invention relates to a method for moving a movable furniture part arranged in or on a body of furniture of a piece of furniture according to the invention, wherein the movable furniture part is pushed out of its closed final position in or on the body of furniture by the electromotor.

Alternatively, provision can be made that the movable furniture part is moved back by the closing device into its closed final position or that the movable furniture part is moved back by the electromotor into its closed final position.

In each case, provision can be made for the closure movement of the movable furniture part or the catch of the closing device to be damped by the electromotor.

Of course, in addition or alternatively, a damping device separate from the electromotor can be provided to damp the closing motion.

The electromotor can be started, for example, by manual actuation of a switch. If a path-measuring device is provided, this can also be used to start the electromotor. For example the motor can be started when the path-measuring device determines that the catch has only been moved a pre-determinable or pre-determined distance.

Further advantages and details of the invention will be apparent with the aid of the following description of the figures which show:

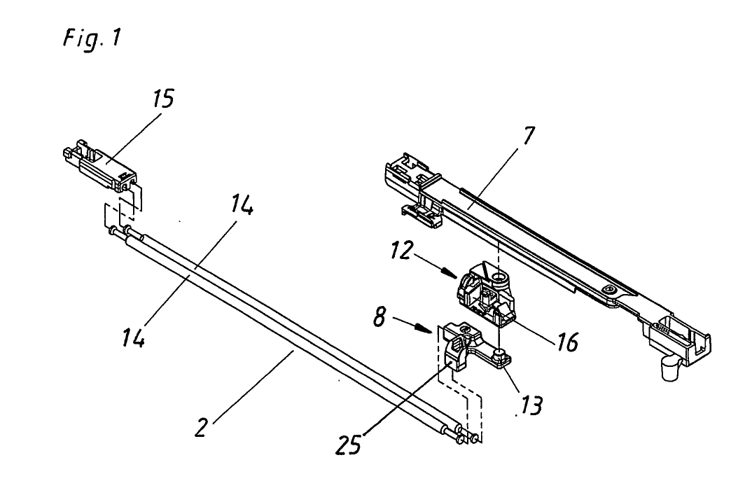

FIG. 1 the exploded view of an embodiment of a closing device known in the art,

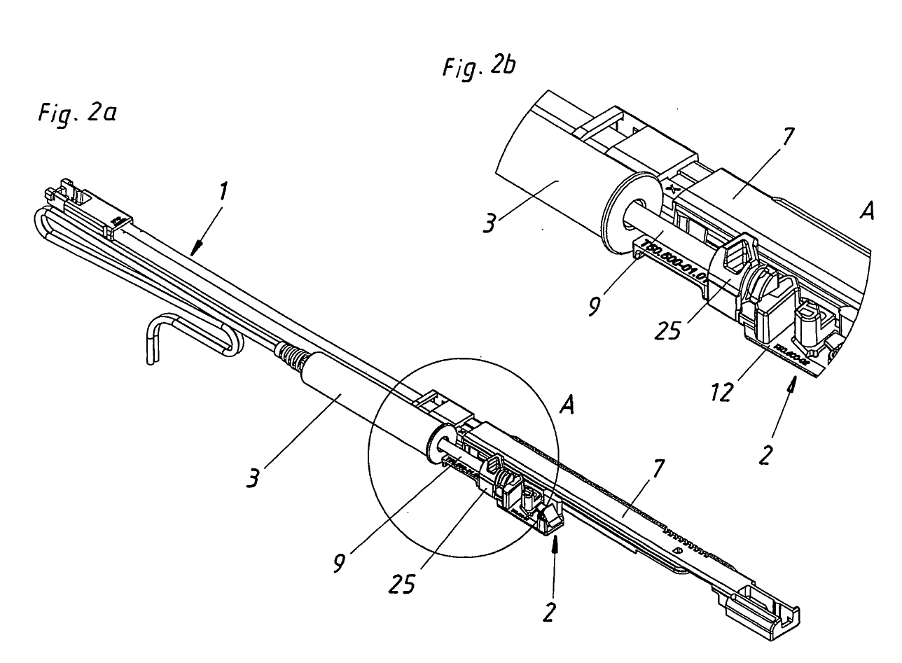

FIG. 2a, 2b a first embodiment of the inventive device in perspective general view and detailed view,

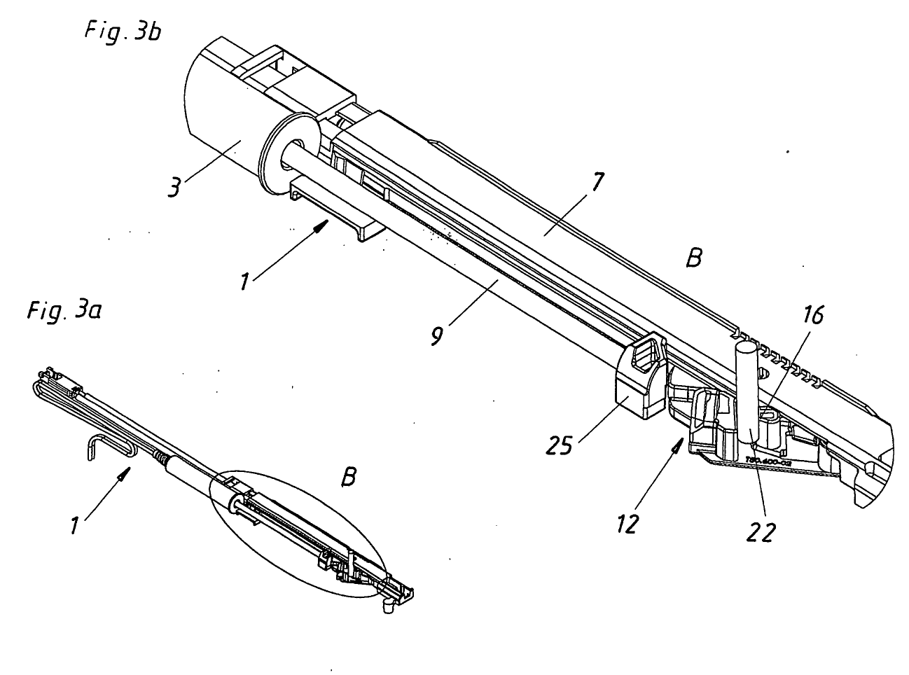

FIG. 3a, 3b the embodiment shown in FIG. 2a, 2b with the catch moved outwards,

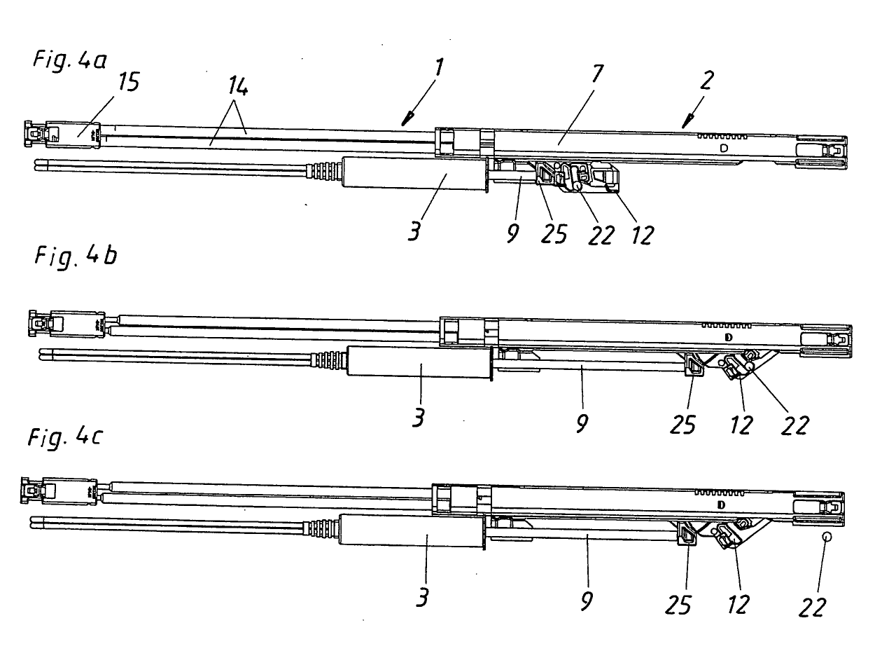

FIG. 4a, 4b,4c the top view of the embodiment shown in FIGS. 2 and 3 in different positions of the catch,

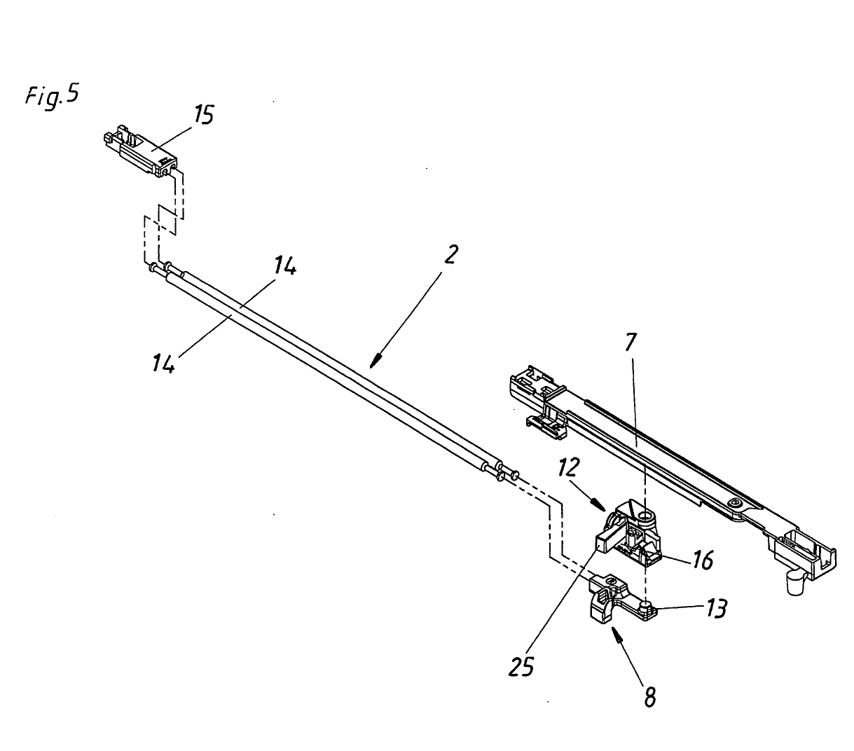

FIG. 5 a further embodiment of a closing device known in the art,

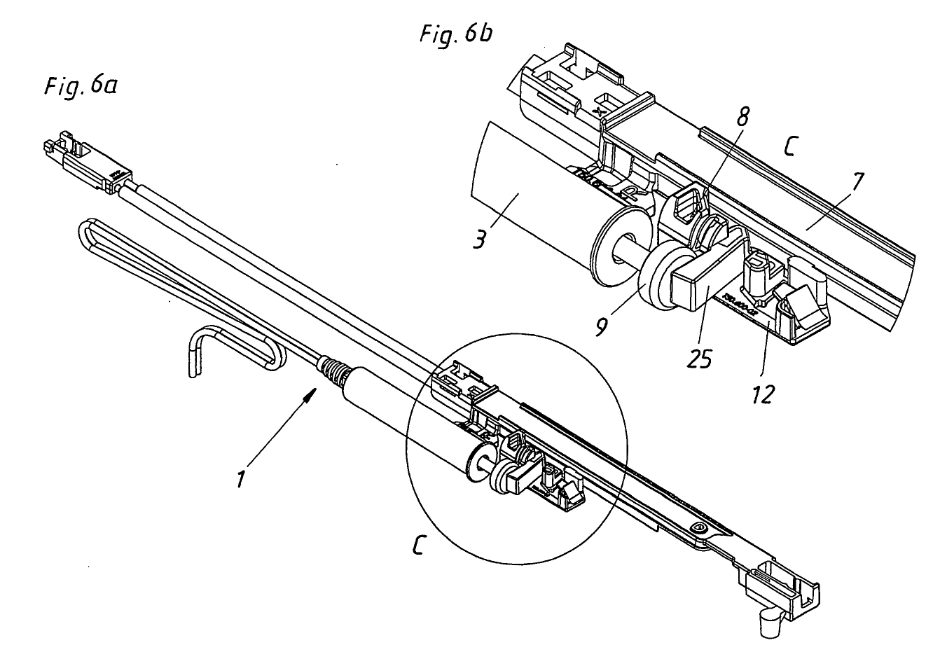

FIG. 6a, 6b a further embodiment of an inventive device in perspective view and detailed view,

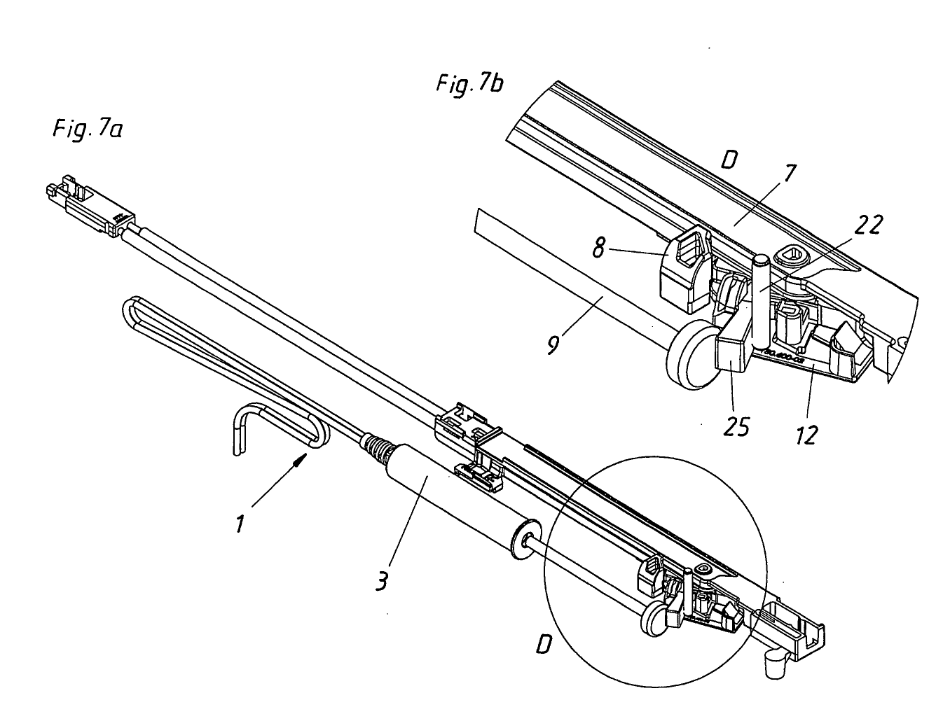

FIG. 7a, 7b the embodiment shown in FIG. 6a, 6b with the catch moved outwards,

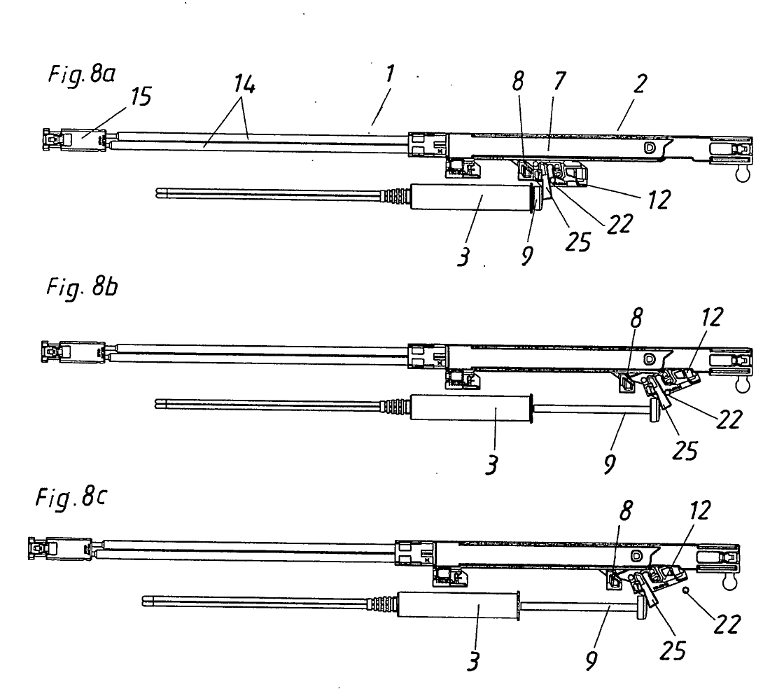

FIG. 8a, 8b, 8c this embodiment in top view in different positions of the catch,

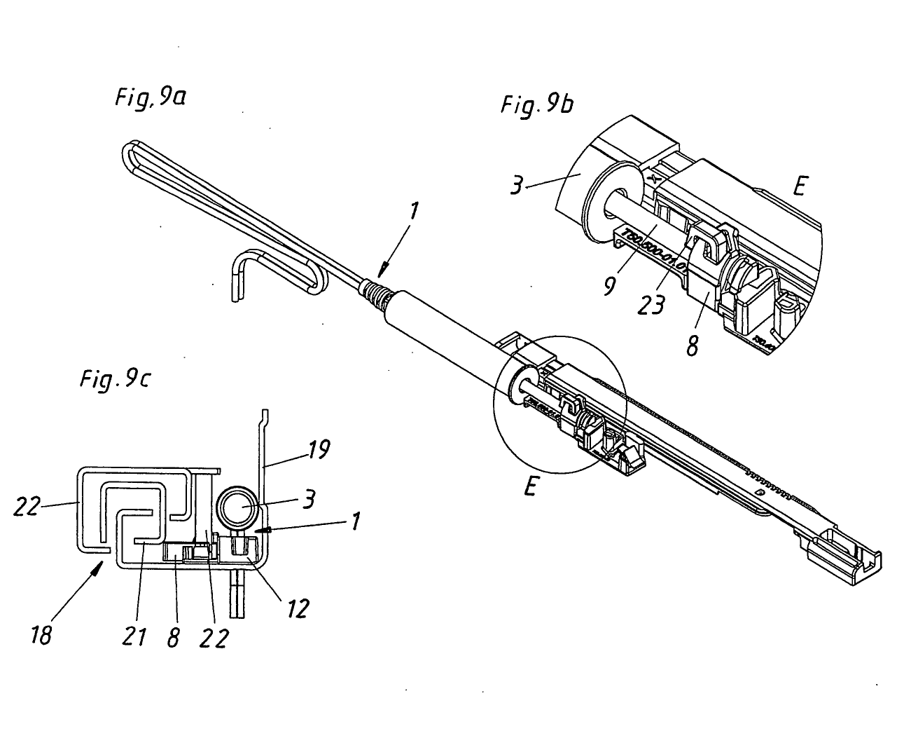

FIG. 9a, 9b, 9c a further embodiment of an inventive device in perspective view, detailed view and in sectional view,

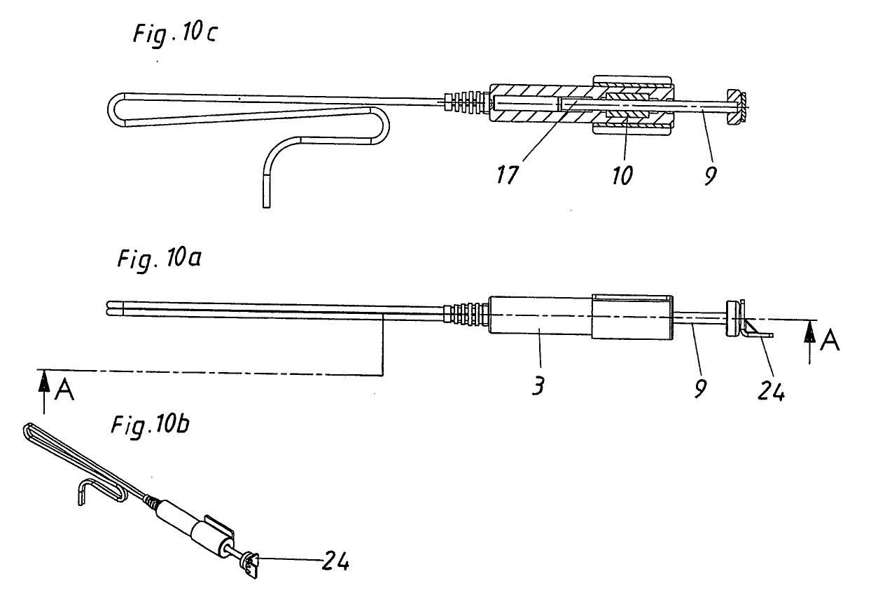

FIG. 10a, 10b, 10c a linear motor in top view, perspective view and sectional view,

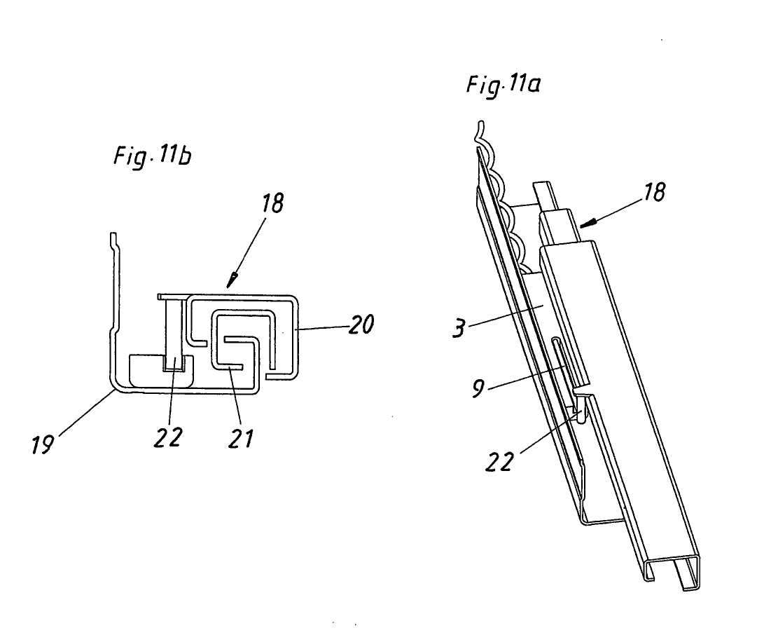

FIG. 11a, 11b an embodiment of an inventive extension guide in perspective view and in sectional view,

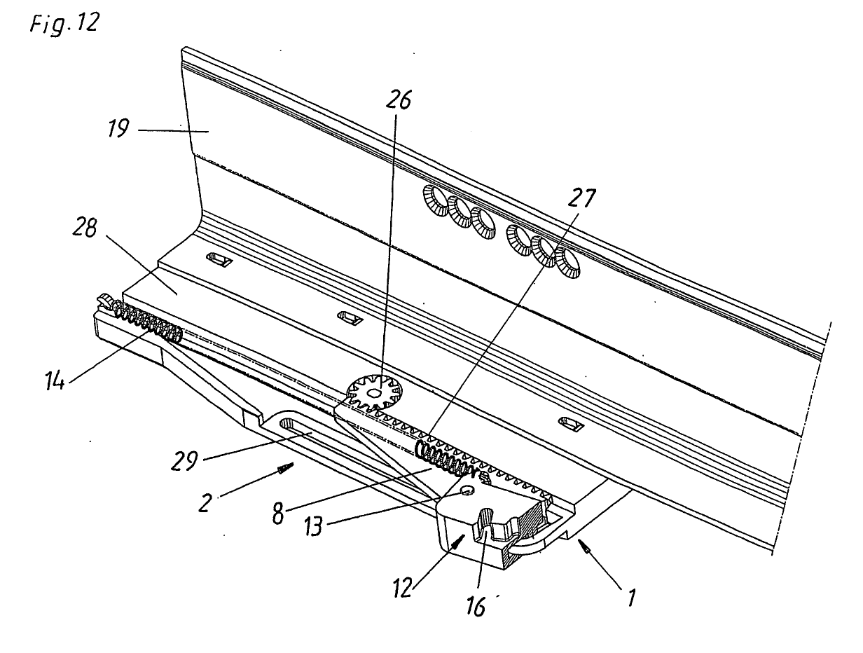

FIG. 12 a further embodiment of an inventive device in perspective view,

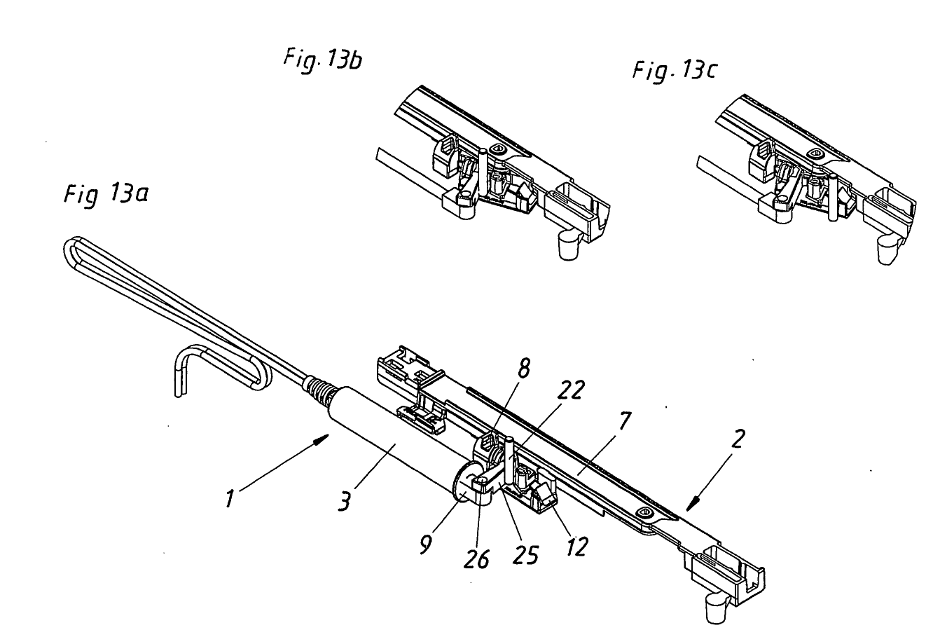

FIG. 13a, 13b, 13c a further embodiment of an inventive device in perspective view and in detailed views, and

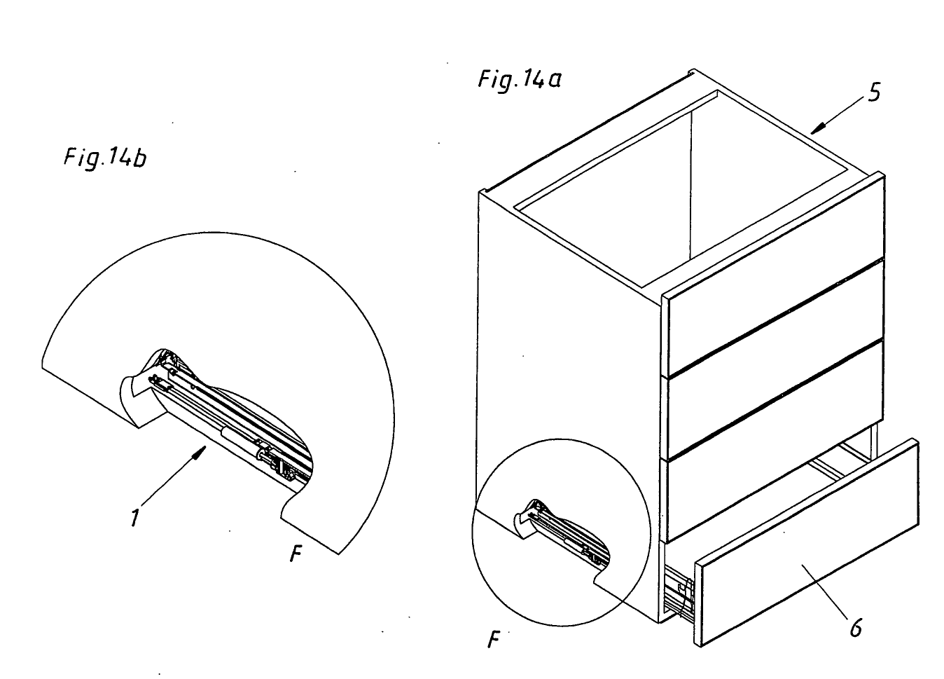

FIG. 14a, 14b a piece of furniture with an inventive device in perspective view and detailed view.

FIG. 1 shows a closing device 2 known in the art with a housing 7 which can for example be anchored on a horizontal web of a mounting rail 19, not shown in FIG. 1, of an extension guide 18.

A slide 8 is disposed so as to be linearly displaceable within a housing 7, whereby a catch 12 is tiltably arranged on the slide 8. The catch 12 is arranged via a lug 13 on the slide 8, said catch 12 having a projection, not shown in FIG. 1, by means of which it is guided into a guideway 29 of the housing 7. Furthermore the slide 8 has a stop 25 for an electromotor 3, not shown in FIG. 1.

Two springs 14 are provided to exert force on the slide 8 in the closing direction, and these are anchored on an anchoring element 15. The anchoring element 15 is distanced from the housing 7 in the assembled position. The distance of the anchoring element 15 from the housing 7 determines the stress of the springs 14.

FIG. 2a shows an inventive device 1 with an electromotor 3 designed as a linear motor. The ram 9 of the electromotor 3 abuts loosely on the stop 25 of the slide 8 of the closing device 2. In the situation shown in FIG. 2a slide 8 and ram 9 are near to their rear final position. In FIG. 2b the catch 12 is partly shown in detail.

In FIGS. 3a and 3b the device 1 is shown with the ram 9 moved out of the housing of the electromotor 3. By moving the ram 9 out, the slide 8 and thus the carrier 12 of the closing device 2 disposed thereon has been brought along the housing 7 of the closing device 2 into the outer final position of the closing device 2 (parking position of the catch 12). Also shown is a pin member 22 disposed on a movable furniture part 6, not shown, or on an extension rail 20 of an extension guide 18, also not shown, which is locked into place in the indentation 16 of the catch 12.

FIGS. 4a, 4b and 4c show a top view of the inventive device 1 at various stages of the opening motion of a movable furniture part 6, not shown.

In FIG. 4a the movable furniture part 6, not shown, is in its closed final position in or on the body of furniture. The pin member 22 abuts on the catch 12 of the closing device 2. The ram 9 of the electromotor 3 abuts loosely on the stop 25 of the slide 8 of the closing device 2. In the situation shown in FIG. 4b, the ram 9 of the electromotor 3 has forced the slide 8 and thus the catch 12 and the pin member 22 outwards, as the result of which the movable furniture part 6 has been moved out of its closed final position in or on the body of furniture. The catch 12 which is tiltably arranged on the slide 8 has thereby been moved into its parking position. The pin member 22 has not yet separated from the catch 12. In FIG. 4c the pin member 22 has separated from the catch 12 and the movable furniture part 6 has moved further in the direction of its fully-open final position.

In FIG. 5 a further embodiment of a closing device 2 known in the art is shown, which only differs from the closing device 2 shown in FIG. 1 in that the projection 25 disposed on the slide 8 in FIG. 1 is now directly arranged on the catch 12.

As can be seen in FIGS. 6a, 6a and 7a, 7b and 8a to 8c, in this embodiment the catch 12 is directly acted upon the ram 9. Here the ram 9 abuts with its free end in the situation shown in FIG. 8a on the projection 25, while the catch 12 and thus the projection 25 in the situations shown in FIGS. 8b and 8c have been moved away by the ram 9.

It is common to both embodiments that during the closing movement of the movable furniture part 6, the pin member 22 locks into place in the indentation 16 of the catch 12 and rotates the catch 12 out of its parking position, as shown in FIGS. 4c and 8c. As soon as the projection 25 of the catch 12 is in the guideway 29 of the housing 7, the springs 14 draw the slide 8 together with the catch 12 backwards, as a result of which the movable furniture part 6 is brought into its closed final position. The ram 9 had thereby been retracted just a short time after the situation shown in FIGS. 4c and 8c respectively into the housing of the electromotor 3.

The embodiment of an inventive device 1 shown in FIGS. 2 to 4 differs from the embodiment of an inventive device 1 shown in FIGS. 9a, 9b and 9c only in that the ram 9 of the electromotor 3 is rigidly connected with the slide 8 of the closing device 2 by a clamp 23, instead of abutting loosely. In FIG. 9c, for example, the arrangement of the device 1 in an extension guide 18 is shown. FIGS. 13a, 13b and 13c show an equally advantageous embodiment which only differs from the embodiment shown in FIGS. 6 to 8 in that the ram 9 of the electromotor 3 is rigidly connected by a joint 26 with the stop 25 of the catch 12 of the closing device 2, instead of loosely abutting. Both alternative embodiments allow the closing motion of the movable furniture part 6 to be supported, as soon as the pin member 22 locks into place in the indentation 16 of the catch 12.

In FIGS. 10a, 10b and 10c, for example, an electromotor 3 is shown in the form of a linear motor. In particular, FIG. 10c shows the runner 17, the stator 10 and the ram 9, whereby the ram 9 is integrated into the runner 17.

In FIGS. 10a and 10b, it can be seen that the ram 9 of the electromotor 3, which takes the form of a linear motor, as an alternative to the aforementioned embodiments, abuts loosely on an angle bracket 24 which can be disposed on an extension rail 20, not shown, or on a movable furniture part 6, not shown.

FIG. 11a shows in perspective view the arrangement of the electromotor 3 shown in FIGS. 10a to 10c on an extension guide 18, which has a mounting rail 19 to be disposed on the body of furniture, an extension rail 20 to be disposed on the movable furniture part 6 and a centre rail 21 (FIG. 11b). Not shown here are carriages and similar disposed between the rails. In FIG. 11b in particular the pin member 22 disposed on the extension rail 20 can be seen.

In FIG. 11a it can be seen that in this embodiment the ram 9 acts directly upon the pin member 22.

FIG. 12 shows another embodiment of an inventive device 1 with a pinion 26 driven by an electromotor 3, not shown. The electromotor 3 drives the slide 8 and with it the catch 12 via a toothed profile 27 formed on the slide 8 of the closing device 2.

In FIG. 14a, a piece of furniture 5 with several movable furniture parts 6 is shown, where the inventive device 1 in this embodiment is disposed in the area of the lowest movable furniture part 6 (see detail view, FIG. 14b).

1. A device for moving a movable furniture part arranged in or on a body of furniture, with a closing device for retracting the movable furniture part into a closed final position in or on the body of furniture, whereby the closing device has a catch to carry the movable furniture part and an energy-storing device to act upon the catch, characterised in that the device comprises an electromotor to drive the catch.

2. The device according to claim 1, characterised in that the movable furniture part is a drawer or a door.

3. The device according to claim 1, characterised in that the energy-storing device comprises a least one spring.

4. The device according to claim 1, characterised in that the catch is detachably coupleable with the movable furniture part.

5. The device according to claim 1, characterised in that the catch is disposed on a displaceable slide.

6. The device according to claim 5, characterised in that the catch is rigidly connected to the slide.

7. The device according to claim 6, characterised in that the catch is made in one piece with the slide.

8. The device according to claim 5, characterised in that the catch is movably connected with the slide.

9. The device according to claim 8, characterised in that the catch is tiltably connected with the slide.

10. The device according to claim 5, characterised in that the energy-storing device of the closing device acts upon the slide.

11. The device according claim 5, characterised in that the device has a ram acted upon the electromotor to act upon the catch or the slide.

12. The device according to claim 11, characterised in that the ram is connected with the catch or the slide.

13. The device according to claim 12, characterised in that the ram is pivotably connected with the slide.

14. The device according to claim 11, characterised in that the ram abuts loosely on the catch or on the slide.

15. The device according to claim 1, characterised in that the energy-storing device of the closing device can be charged by the electromotor.

16. The device according to claim 1, characterised in that the electromotor comprises a stator.

17. The device according to claim 16, characterised in that the stator comprises at least one electromagnet.

18. The device according to claim 16, characterised in that the electromotor comprises a rotor rotatably disposed with respect to the stator.

19. The device according to claim 18, characterised in that the rotor comprises at least one permanent magnet.

20. The device according to claim 1, characterised in that the electromotor is in the form of an electrical linear motor.

21. The device according to claim 20, characterised in that the linear motor comprises a stator.

22. The device according to claim 21, characterised in that the stator comprises at least one electromagnet.

23. The device according to claim 21, characterised in that the linear motor comprises a runner which is linearly displaceable with respect to the stator.

24. The device according to claim 23, characterised in that the runner comprises at least one permanent magnet.

25. The device according to claim 20, characterised in that the device comprises a ram acted upon the linear motor to act upon the catch.

26. The device according to claim 23, characterised in that the ram is disposed on the runner.

27. The device according to claim 26, characterised in that the ram is made in one piece with the runner.

28. The device according to claim 1, characterised in that a path-measuring device is integrated into the electromotor.

29. The device according to claim 28, characterised in that the path-measuring device comprises an inductive or capacitive sensor.

30. An extension guide for a movable furniture part arranged in or on a body of furniture with an extension rail attachable to the movable furniture part and a mounting rail attachable to the body of furniture, characterised in that it has a device according to claim 1.

31. The extension guide according to claim 30, characterised in that the movable furniture part is a drawer or a door.

32. The extension guide according to claim 30, characterised in that the electromotor is disposed on the mounting rail.

33. The extension guide according to claim 30, characterised in that the closing device is disposed on the mounting rail.

34. The extension guide according to claim 30, characterised in that a pin member is disposed on the extension rail.

35. The extension guide according to claim 34, characterised in that the pin member can be acted upon the electromotor.

36. The extension guide according to claim 34, characterised in that the pin member is detachably coupleable with the catch of the closing device.

37. A piece of furniture with at least one movable furniture part, characterised by a device according to claim 1, wherein the device is disposed in an extension guide.

38. The piece of furniture according to claim 37, characterised in that the movable furniture part is a drawer or a door.

39. The piece of furniture according to claim 37, characterised in that the movable furniture part can be retracted by the closing device at least over a part of the total opening path leading up to the closed final position of the movable furniture part.

40. A method for moving a movable furniture part arranged in or on a body of furniture of a piece of furniture according to claim 37, characterised in that the movable furniture part is ejected from its closed final position in or on the body of furniture by the electromotor.

41. The method according to claim 40, characterised in that the movable furniture part is moved back into its final closed position by the closing device.

42. The method according to claim 40, characterised in that the movable furniture part is moved back into its final closed position by the electromotor.

43. The method according to claim 40, characterised in that the closing movement of the movable furniture part is damped by the electromotor.
